(19) United States
(12) Patent Application Publication
(10) Pub. No.: US 2014/0092212 A1
(43) Pub. Date: Apr. 3, 2014

(54) INFORMATION PROCESSOR, INFORMATION PROCESSING PROGRAM, AND INFORMATION PROCESSING METHOD

(71) Applicant: KABUSHIKI KAISHA TOSHIBA, Tokyo (JP)

(72) Inventors: Takayoshi ITO, Yokohama-Shi (JP); Tetsuya KAISE, Tokyo (JP)

(73) Assignee: KABUSHIKI KAISHA TOSHIBA, Tokyo (JP)

(21) Appl. No.: 14/021,929

(22) Filed: Sep. 9, 2013

(30) Foreign Application Priority Data
Oct. 1, 2012 (JP) 2012-219747

(51) Int. Cl. H04N 5/60; H04N 13/04

(52) U.S. Cl. CPC H04N 5/607; H04N 13/0454
USPC 348/43; 381/56; 348/485

(57) ABSTRACT

An information processor has a sound acquisition unit configured to acquire a sound in a surrounding environment, a volume judging unit configured to judge whether a volume level of the sound acquired by the sound acquisition unit is higher than a reference level previously set, and a first reproduction position information recorder configured to record reproduction position information showing a current reproduction position of digital content, when the volume judging unit judges that the volume level of the acquired sound is higher than the reference level.

### CROSS REFERENCE TO RELATED APPLICATIONS

This application is based upon and claims the benefit of priority from the prior Japanese Patent Application No. 2012-219747, filed on Oct. 1, 2012, the entire contents of which are incorporated herein by reference.

### FIELD

Embodiments of the present invention relate to an information processor capable of reproducing digital content, and to an information processing program.

### BACKGROUND

With the improvement in the performance of digital devices, standardization of management techniques for protecting the copyright of digital content, and development of copyright laws, there is an increased number of users storing program data recorded by digital TV, recorder, PC, etc. in a handheld terminal to view the program outside the home. The digital content viewed outside the home includes not only video, but also music and sound, and there are various purposes of using the digital content such as hobby, business, learning, etc.

Viewing digital content outside the home is generally more difficult than at home since the noise level in the surrounding environment is high in some locations.

As a practical technique to lower the noise level in the surrounding environment, headphones having a noise cancelling function are used. However, it is not always effective to use such headphones, which are generally expensive and can reduce only limited kinds of noises.

As another technique, it is suggested to acquire a sound in the surrounding environment by a microphone in order to temporarily stop reproduction when the sound is judged to be a noise, and to restart reproduction when the noise disappears.

However, when a noise intermittently occurs at short intervals, the user feels uncomfortable since reproduction is stopped on each occasion. For example, even when the user viewing video cannot hear the sound due to a noise, it is not rare that the user can grasp the content only with the video. If reproduction is forcibly stopped in such a case, usability is remarkably deteriorated.

### BRIEF DESCRIPTION OF THE DRAWINGS

FIG. 1 is a block diagram showing a schematic structure of an information processor 1 according to a first embodiment.

FIG. 2 is a block diagram showing a schematic structure of the information processor 1 according to a second embodiment.

FIG. 3 is a block diagram showing a schematic structure of the information processor 1 according to a third embodiment.

FIG. 4 is a block diagram showing a schematic structure of the information processor 1 according to a fourth embodiment.

FIG. 5 is a block diagram showing a schematic structure of the information processor 1 according to a fifth embodiment.

FIG. 6 is a block diagram showing a schematic structure of the information processor 1 according to a sixth embodiment.

FIG. 7 is a diagram schematically showing a reproduction procedure when the information processor 1 of FIGS. 1 to 4 is provided with a Back button 10.

FIG. 8 is a block diagram showing a schematic structure of the information processor 1 according to a seventh embodiment.

FIG. 9 is a diagram schematically showing an example of the procedure performed by the information processor 1 of FIG. 8.

FIG. 10 is a block diagram showing a schematic structure of the information processor 1 according to a modification example derived from the seventh embodiment.

FIG. 11 is a diagram schematically showing a reproduction procedure performed by the information processor 1 of FIG. 10.

FIG. 12 is a diagram showing a screen example displayed on the information processor 1 according to an eighth embodiment.

### DETAILED DESCRIPTION

According to one embodiment, an information processor has a sound acquisition unit configured to acquire a sound in a surrounding environment, a volume judging unit configured to judge whether a volume level of the sound acquired by the sound acquisition unit is higher than a reference level previously set, and a first reproduction position information recorder configured to record reproduction position information showing a current reproduction position of digital content, when the volume judging unit judges that the volume level of the acquired sound is higher than the reference level.

Hereinafter, embodiments of the present invention will be explained referring to the drawings. The information processor according to each embodiment to be explained below is incorporated into an electronic device capable of reproducing digital content, such as a smartphone. Explanation will be given mainly on an example of viewing AV (Audio & Visual) data including video by using such an information processor, but the information processor can also be used only to listen to the sound.

### First Embodiment

A first embodiment is characterized in that only a part of digital content can be reproduced again with a simple operation when the part cannot be heard due to a noise occurring when the digital content is reproduced.

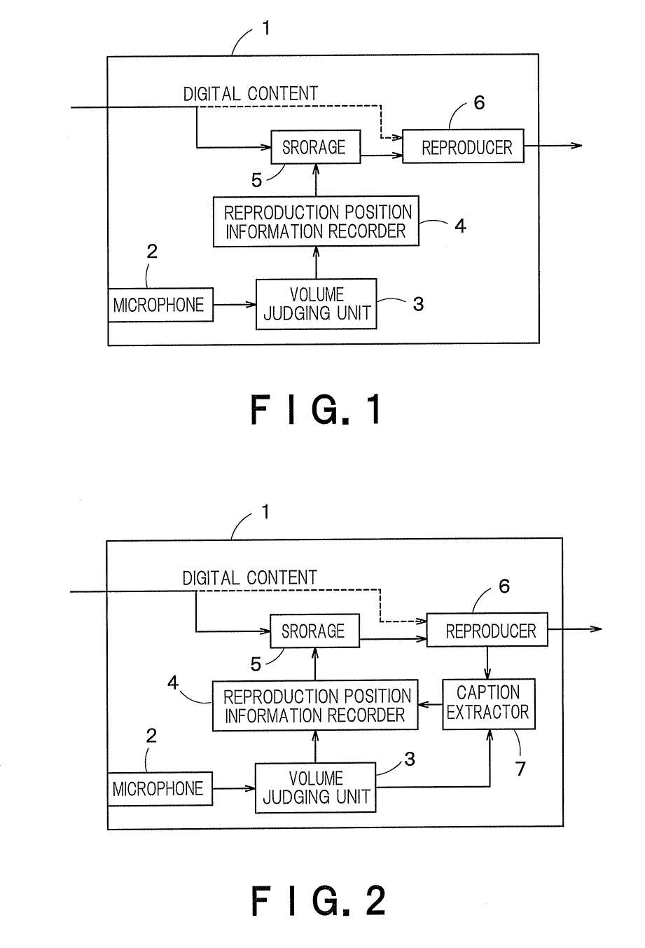

FIG. 1 is a block diagram showing a schematic structure of an information processor 1 according to the first embodiment. The information processor 1 of FIG. 1 has a microphone (sound acquisition unit) 2, a volume judging unit 3, a reproduction position information recorder (first reproduction position information recorder) 4, a storage 5, and a reproducer 6.

The information processor 1 of FIG. 1 is an electronic device capable of reproducing digital content, and may further have a display device and a speaker (not shown in FIG. 1). When the information processor 1 can reproduce only the sound, the display device may be omitted. Further, headphones may be used instead of the speaker to listen to the sound of digital content.

The microphone 2 acquires a sound in the surrounding environment of the information processor 1. The volume judging unit 3 judges whether the volume level of the sound acquired by the microphone 2 is higher than a reference level previously set.

When the volume judging unit 3 judges that the volume level of the sound acquired by the microphone 2 is high and exceeds the reference level, the reproduction position information recorder 4 judges that a noise at a level of disturbing listening has occurred and records reproduction position information showing the current reproduction position of digital content. The recorded reproduction position information is stored in the storage 5.

When a user views digital content while listening to the sound from the speaker of the information processor 1, the microphone 2 acquires the original sound included in the digital content together with a noise unrelated to this sound. Therefore, the volume judging unit 3 sets the reference level depending on the volume of speaker sound included in the sound acquired by the microphone 2. More concretely, the reference level is set higher as the speaker volume becomes higher.

When the information processor 1 has a speaker therein, the volume level of the speaker can be previously detected, and thus the reference level should be set depending on the detected volume level. Instead, the user may arbitrarily change and set the reference level.

On the other hand, when the user views digital content using headphones, the microphone 2 acquires almost only a noise. Therefore, the volume judging unit 3 can set the reference level nearly at a constant level. It is considered that resistance to noises increases as the volume of the headphones increases, and thus the reference level in the volume judging unit 3 may be set higher as the volume of the headphones becomes higher.

Digital content reproduced by the information processor 1 is stream data such as airwaves reproduced in real time without being stored in the information processor 1, or accumulation-type data such as recorded data stored in the information processor 1 to be reproduced. Stream data does not require the storage 5 for accumulating digital content in the information processor 1, but accumulation-type data requires the storage 5 for storing digital content. In this case, the reproduction position information related to the digital content should be stored in the storage 5 originally provided to store digital content. More concretely, digital content is composed of a content body and header information, and the reproduction position information is included in the header information. In this case, the storage 5 for storing the reproduction position information is provided in the storage 5 for storing digital content.

On the other hand, in the case of stream data, stream data inputted from the outside is inputted into the reproducer 6 as shown by the broken-line arrow in FIG. 1, and reproduced without being accumulated in the storage 5.

When the digital content to be reproduced is encrypted, the reproducer 6 decrypts the digital content and reproduces it from a specified reproduction position. As stated above, digital content to be reproduced by the reproducer 6 is AV data including video, or AV data including only sound (without video).

When an instruction is given by a Back button etc. (mentioned later) to reproduce digital content from the reproduction position corresponding to the reproduction position information recorded by the reproduction position information recorder 4, the reproducer 6 reproduces the digital content from this reproduction position.

As stated above, in the first embodiment, when the noise in the surrounding environment becomes loud while digital content is reproduced, reproduction position information at that point is recorded. Since the part to be reproduced again can be changed easily based on the recorded reproduction position information, only the part which could not be heard due to a loud noise can be reproduced again. Accordingly, even if a noise occurs when digital content is reproduced, the missed part can be reproduced again with a simple operation.

### Second Embodiment

A second embodiment is characterized in that the reproduction position information is recorded based on a renewal position of caption information included in digital content.

FIG. 2 is a block diagram showing a schematic structure of the information processor 1 according to the second embodiment. The information processor 1 of FIG. 2 has a caption extractor 7 in addition to the components of FIG. 1. The caption extractor 7 extracts, from the digital content to be reproduced, a renewal position of caption information.

When the volume level of the sound acquired by the microphone 2 is higher than the reference level, the reproduction position information recorder 4 according to the present embodiment records, as the reproduction position information, a renewal position of caption information preceding the current reproduction position of the digital content.

The caption information is generally related to video data of the content body. The caption information is not included in every scene of the video data, and not included also in a normal commercial message interposed in the content body. Since the timing when a loud noise occurs does not synchronize with the reproduction timing of digital content, a noise may possibly occur in the middle of a caption sentence or a commercial message. When the reproduction position at the point when a noise occurs is correctly recorded in order to reproduce the digital content again from this position, the digital content may possibly be reproduced again from the middle of a caption sentence or a commercial message. It must be convenient for the user to reproduce the digital content again from a renewal position of the caption in order to grasp the substance of the content, and there must be few users who want to reproduce the digital content again from the commercial message.

Accordingly, in the present embodiment, when a noise becomes loud, a renewal position of the caption information is recorded as the reproduction position information so that the digital content can be reproduced again from the renewal position of the caption information when the user instructs to change the reproduction position by the Back button etc. (mentioned later). More specifically, reproduction is restarted from a renewal position (i.e., beginning) of the caption information preceding the point when the noise occurs. Since the user can view whole of the caption information preceding the point when the noise occurs, it is possible to grasp the reproduced information more easily. Further, reproducing digital content from the beginning of the caption information makes it possible to prevent the digital content from being reproduced again from the middle of a commercial message.

Note that the caption information is separated from the video data of digital content to serve as character information, or previously synthesized with the video data of digital content. When the caption information is provided as character information, a pause between caption sentences can be detected relatively easily, which makes it easy to detect a renewal position of the caption information. On the other hand, when the caption information is synthesized with the video data of digital content, a renewal position of the caption information must be detected by converting the caption information into character information utilizing an OCR technology.

As stated above, in the second embodiment, the reproduction position information is recorded based on a renewal position of the caption information included in digital content, which makes it possible to reproduce the digital content again from the point when a noise occurs, not from the middle of a caption or a commercial message. Thus, usability of the user is improved.

### Third Embodiment

A third embodiment is characterized in that the reproduction position information is recorded based on a silent period included in digital content.

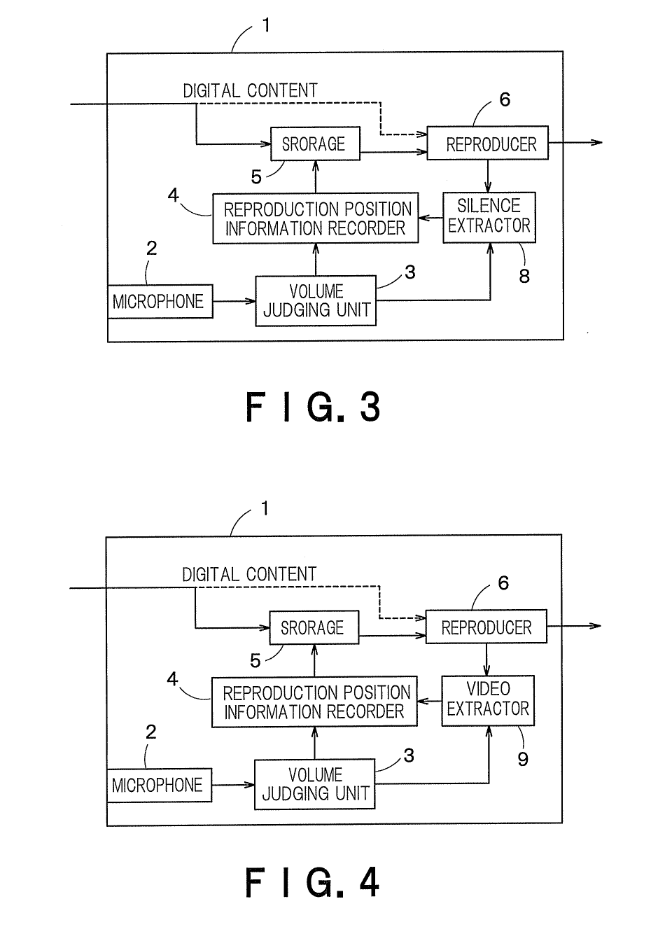

FIG. 3 is a block diagram showing a schematic structure of the information processor 1 according to the third embodiment. The information processor 1 of FIG. 3 has a silence extractor 8 in addition to the components of FIG. 1. The silence extractor 8 extracts, from the digital content to be reproduced, a silent period of a predetermined time length or longer.

More specifically, when a relative volume level of digital content is continuously equal to or higher than a predetermined reference level for a period of a predetermined time length or longer time length, the silence extractor 8 extracts the period as the silent period.

When the volume level of the sound acquired by the microphone 2 is higher than the reference level, the reproduction position information recorder 4 according to the present embodiment records, as the reproduction position information, the end position of a silent period preceding the current reproduction position of the digital content.

Since viewing is not influenced by a noise occurring in the silent period of digital content, it should be unnecessary to reproduce the digital content again from the point when a loud noise occurred in the silent period. Thus, when a loud noise occurs in the silent period of digital content, the ending time of the silent period is recorded as the reproduction position information so that the digital content can be reproduced again from the ending time of the silent period when the user instructs to change the reproduction position by the Back button etc. as mentioned later.

According to the third embodiment, when a loud noise occurs in the silent period of digital content, the digital content can be reproduced again from the end of the silent period, by which the part missed due to a noise can be heard efficiently in a short time.

### Fourth Embodiment

A fourth embodiment is characterized in that the reproduction position information is recorded based on a switching position from two-dimensional video data to three-dimensional video data included in digital content.

FIG. 4 is a block diagram showing a schematic structure of the information processor 1 according to the fourth embodiment.

The information processor 1 of FIG. 4 has a video extractor 9 in addition to the components of FIG. 1. The video extractor 9 extracts, from the digital content to be reproduced, a switching position from two-dimensional (2D) video data to three-dimensional (3D) video data.

When the volume level of the sound acquired by the microphone 2 is higher than the reference level, the reproduction position information recorder 4 according to the present embodiment records, as the reproduction position information, a switching position from 2D data to 3D data preceding the current reproduction position of the digital content.

Recently, 3D digital content has increased with the spread of TV and PC having a display device supporting 3D viewing. Since a great expense is required to produce 3D digital content, it is general to use 3D data in only a part of digital content, or to use 3D data wholly in the content body while using 2D data in a commercial message interposed in the content body.

In the present embodiment, 3D data included in digital content is judged to be important, and the reproduction position information is recorded based on a position at which 2D data switches to 3D data, that is, based on the beginning of 3D data. More specifically, if a loud noise occurs when digital content is reproduced, the preceding position at which 2D data switches to 3D data is recorded as the reproduction position information.

As stated above, in the fourth embodiment, if a loud noise occurs when digital content is reproduced, the digital content can be reproduced again from the preceding position at which 2D data switches to 3D data, with a simple operation. This prevents the user from missing the sound of 3D data.

As a modification example derived from the fourth embodiment, a position at which monaural sound of digital content switches to stereo sound may be recorded as the reproduction position information. Stereo sound included in digital content is judged to be important, and monaural sound is often used in a commercial message etc. interposed in digital content. Accordingly, when a loud noise is detected, the preceding position at which monaural sound switches to stereo sound is recorded as the reproduction position information so that the digital content can be reproduced again from the beginning of the preceding stereo sound when the user instructs to change the reproduction position by the Back button etc.

### Fifth Embodiment

None of the above the first to fourth embodiments shows a concrete means for giving an instruction to return to the reproduction position recorded by the reproduction position information recorder 4. On the other hand, a fifth embodiment is characterized in providing a Back button as a concrete means for this instruction.

The Back button should not necessarily be a physical button having a mechanical contact point. The Back button may be a button having an electric contact point incorporated in a touch panel, or a virtual instructing unit which detects the finger position or gesture of the user by image recognition or detects the voice of the user by voice recognition.

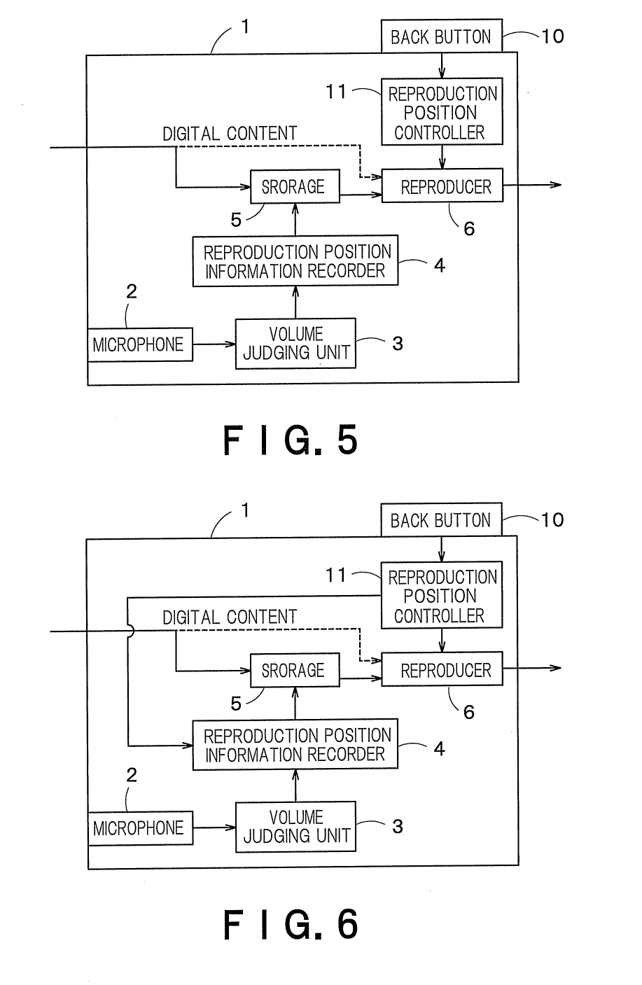

FIG. 5 is a block diagram showing a schematic structure of the information processor 1 according to the fifth embodiment. FIG. 5 is obtained by newly adding a Back button 10 and a reproduction position controller 11 to the information processor 1 shown in FIG. 1. The Back button 10 is operated by the user when user wants to return to the reproduction position recorded by the reproduction position information recorder 4.

The reproduction position controller 11, when detecting that the Back button 10 is operated by the user, instructs the reproducer 6 to change the reproduction position. The reproducer 6 receives the instruction and reads a reproduction position recorded by the reproduction position information recorder 4 to change the current reproduction position.

Note that the Back button 10 and the reproduction position controller 11 may be added to the information processor 1 shown in FIGS. 2 to 4.

As stated above, in the fifth embodiment, the Back button 10 is provided to return to a reproduction position recorded by the reproduction position information recorder 4, which makes it possible for the user to change the reproduction position at an arbitrary timing. Thus, usability of the user is improved.

### Sixth Embodiment

A sixth embodiment to be explained below is a modification example derived from the fifth embodiment, and characterized in recording the reproduction position of digital content reproduced immediately before the Back button 10 is operated by the user.

FIG. 6 is a block diagram showing a schematic structure of the information processor 1 according to the sixth embodiment. In the information processor 1 of FIG. 6, the reproduction position controller 11 detects that the Back button 10 is operated by the user, and transfers the detected information to the reproduction position information recorder 4. The reproduction position information recorder 4 records the reproduction position of digital content reproduced when the Back button 10 is operated by the user, and stores the recorded reproduction position in the storage 5.

The reproduction position of digital content reproduced when the Back button 10 is operated by the user is recorded so that the user can reproduce the part which could not be heard due to a noise again and return to the original reproduction position at an arbitrary timing after checking the part.

Similarly to the fifth embodiment, when the Back button 10 is operated by the user, the reproducer 6 reproduces the digital content from the reproduction position stored in the storage 5, and after that, when the Back button 10 is operated again by the user, the reproducer reproduces the digital content from the reproduction position recorded when the Back button 10 is operated first by the user.

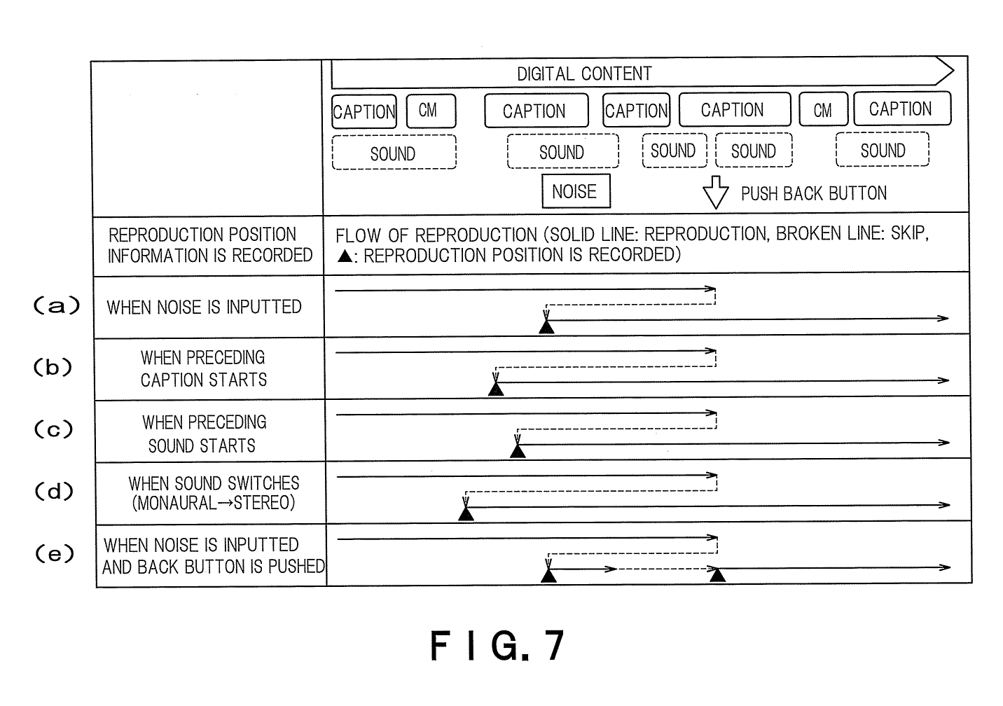

FIG. 7 is a diagram schematically showing a reproduction procedure when the information processor 1 of FIGS. 1 to 4 is provided with the Back button 10. FIG. 7(a) shows a reproduction procedure when providing the Back button 10 to the information processor 1 of FIG. 1, FIG. 7(b) shows a reproduction procedure when providing the Back button 10 to the information processor 1 of FIG. 2, FIG. 7(c) shows a reproduction procedure when providing the Back button 10 to the information processor 1 of FIG. 3, and FIG. 7(d) shows a reproduction procedure when providing the Back button 10 to the information processor 1 of FIG. 4. In FIGS. 7(a) to (d), a black triangular mark represents a reproduction position recorded when a noise occurs.

FIG. 7(e) shows a reproduction procedure performed by the information processor 1 of FIG. 6. The black triangular mark on the left represents a reproduction position recorded when a noise occurs, and the black triangular mark on the right represents a reproduction position recorded when the Back button 10 is operated first.

In each of the cases (a) to (d) in FIG. 7, when the Back button 10 is operated by the user, the digital content is reproduced again from the recorded reproduction position. On the other hand, in the case of FIG. 7(e), when the Back button 10 is operated first by the user, the digital content is reproduced again from the recorded reproduction position, and after that, when the Back button 10 is operated again by the user, the digital content is reproduced from the reproduction position recorded when the Back button 10 is operated first.

As stated above, in each of the cases (a) to (d) in FIG. 7, when the Back button 10 is operated, the digital content is reproduced again from the recorded reproduction position. Thus, even when a loud noise momentarily occurs, the digital content can be continuously reproduced again from the point of the noise occurrence. On the other hand, in the case of FIG. 7(e), it is possible to reproduce only the part missed due to a noise again, and return directly to the reproduction position recorded when the Back button 10 is operated, skipping the successfully heard part.

As stated above, in the sixth embodiment, when the Back button 10 is operated by the user, the reproduction position of digital content reproduced immediately before is recorded and the digital content is reproduced from the preceding reproduction position stored in the storage 5, and after that, when the Back button 10 is operated again by the user, the digital content is reproduced from the reproduction position recorded when the Back button 10 is operated first. Since the user can reproduce only the part missed due to a noise and return directly to the original reproduction position, reproduction can be performed efficiently.

In FIG. 6, the reproduction position at the point when the user could not hear the digital content due to a noise and the reproduction position at the point when the Back button 10 is operated by the user are both recorded in the reproduction position information recorder 4. However, instead of the reproduction position information recorder 4, it is possible to provide a first reproduction position information recorder for recording the reproduction position at the point when the user could not hear the digital content due to a noise, and a second reproduction position information recorder for recording the reproduction position at the point when the Back button 10 is operated by the user. Further, the separate recording units may be integrated into one as the reproduction position information recorder 4 of FIG. 6.

Further, in FIG. 6, when the Back button 10 for instructing to reproduce the digital content from the reproduction position stored in the storage 5 is operated again, the digital content is reproduced from the reproduction position recorded immediately before the Back button 10 is operated first. However, instead of the Back button 10, it is possible to provide a first Back button for instructing to reproduce the digital content from the reproduction position stored in the storage 5 and a second Back button for instructing to reproduce the digital content from the reproduction position immediately before the Back button is operated first. Further, the buttons may be integrated into one.

### Seventh Embodiment

A seventh embodiment to be explained below is characterized in that the reproduction position information once recorded can be erased.

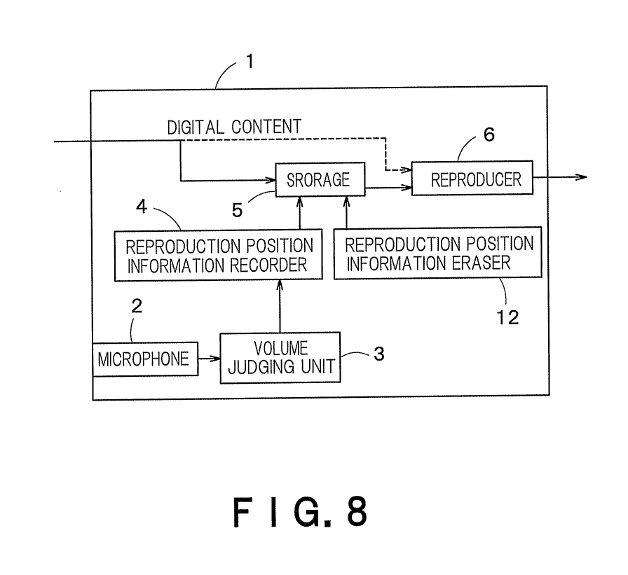

FIG. 8 is a block diagram showing a schematic structure of the information processor 1 according to the seventh embodiment. The information processor 1 of FIG. 8 is obtained by newly adding a reproduction position information eraser 12 to the information processor 1 of FIG. 1.

The reproduction position information eraser 12 erases at least a piece of reproduction position information recorded by the reproduction position information recorder 4 when the number of pieces of reproduction position information recorded within a predetermined time interval exceeds a predetermined threshold value.

That is, when a loud noise occurs intermittently in a short time, the reproduction position information recorder 4 records many pieces of reproduction position information in a short time. In such a case, it is convenient for the user if the missed parts can be reproduced again with one-time operation without jumping to every reproduction position. Further, since the capacity of the storage 5 for storing the reproduction position information is limited, it may be impossible for the storage 5 to completely store the reproduction position information when many noises intermittently occur in a short time.

Accordingly, in the present embodiment, when a plurality of pieces of reproduction position information are recorded in a short time, the pieces of reproduction position information are reduced. More concretely, the reproduction position information eraser 12 is provided to erase at least a piece of reproduction position information when the number of pieces of reproduction position information measured within a predetermined time interval exceeds a predetermined threshold value.

When reducing the reproduction position information, only a piece of reproduction position information at the head of a series of pieces of reproduction position information should be kept while erasing the other pieces of reproduction position information. By reproducing the digital content again from the leading reproduction position, the other erased reproduction positions can also be reproduced.

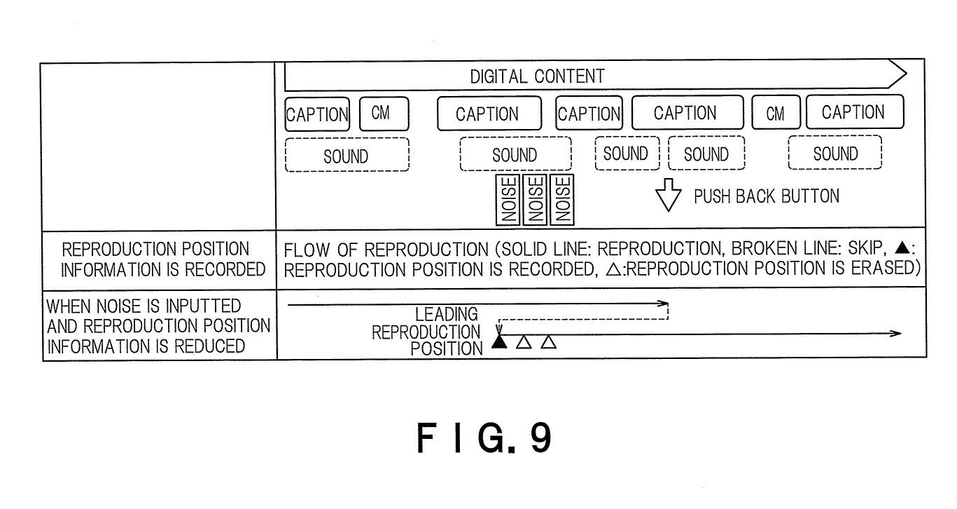

FIG. 9 is a diagram schematically showing an example of the procedure performed by the information processor 1 of FIG. 8. In the example of FIG. 9, the reproduction position information is recorded three times sequentially in a short time. In this case, it is desirable to keep only the leading piece of reproduction position information while erasing the other pieces of reproduction position information, as stated above.

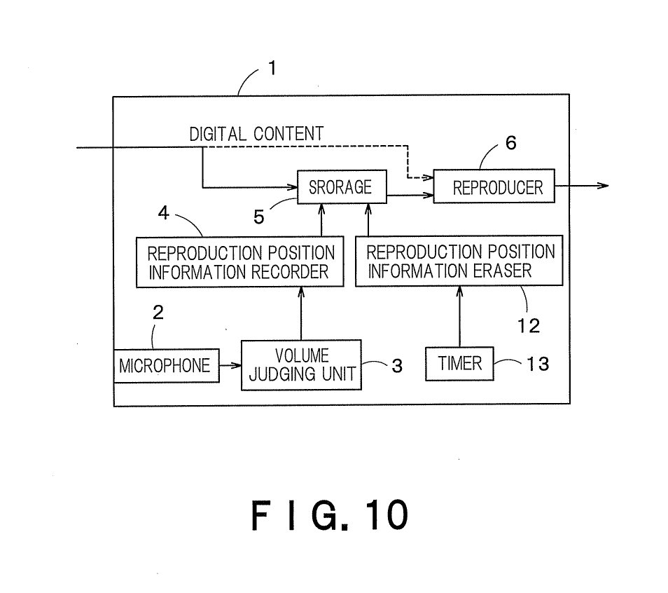

How to reduce the reproduction position information should not necessarily be limited to the technique shown in FIG. 9. FIG. 10 is a block diagram showing a schematic structure of the information processor 1 according to a modification example derived from the seventh embodiment. The information processor 1 of FIG. 10 is obtained by newly providing a timer 13 to the components of FIG. 8. The timer 13 measures the time elapsed since the reproduction position information was recorded by the reproduction position information recorder 4. The reproduction position information eraser 12 erases the reproduction position information when the elapsed time measured by the timer 13 exceeds a predetermined time.

Generally, it is assumed that the reproduction position information recorded a long time before is less important to the user than the reproduction position information recorded a short time before. Accordingly, pieces of reproduction position information are sequentially erased in chronological order of storage regardless of whether the storage 5 is filled with the reproduction position information.

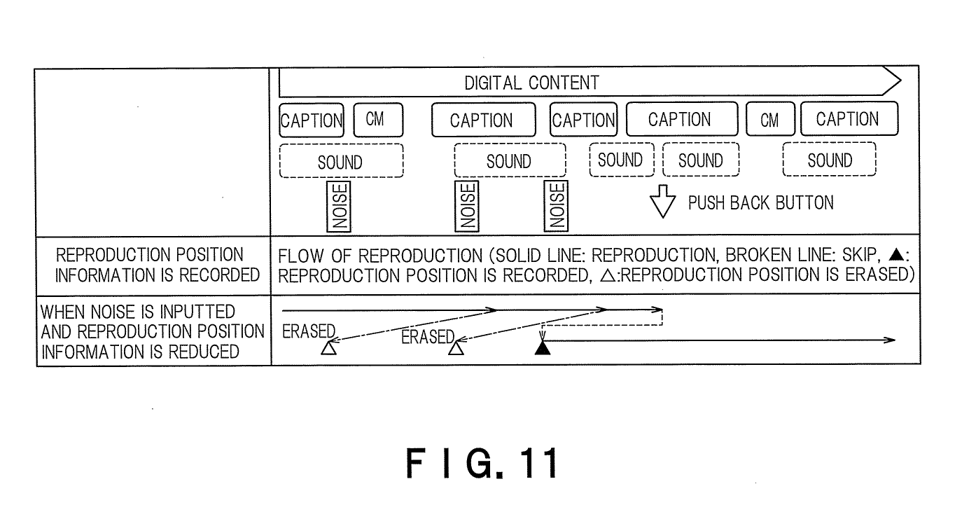

FIG. 11 is a diagram schematically showing a reproduction procedure performed by the information processor 1 of FIG. 10. FIG. 11 shows an example where the Back button 10 is operated by the user after the reproduction position information is recorded three times at odd intervals. The reproduction position information eraser 12 of FIG. 10 erases the reproduction position information from the storage 5 when a predetermined time has passed since the reproduction position information was recorded. In FIG. 11, the reproduction position information recorded first and the reproduction position information recorded second are erased before the Back button 10 is operated by the user. Accordingly, at the point when the Back button 10 is operated by the user, the storage 5 contains only the reproduction position information recorded third, and the digital content is reproduced again from this reproduction position.

As stated above, in the seventh embodiment, even when a plurality of pieces of reproduction position information are recorded, old information is automatically eliminated, which makes it possible to select a reproduction position from a narrow range. Since the reproduction position information recorded a long time before is generally unnecessary for the user, old information is automatically eliminated so that the digital content can be reproduced again automatically from the reproduction position which should be requested by the user. Thus, usability of the user is improved.

### Eighth Embodiment

An eighth embodiment to be explained below is characterized in that a mark (index) showing the current reproduction position and a mark (index) showing the reproduction position recorded by the reproduction position information recorder 4 are displayed on a screen so that the user can simply select the reproduction position with a pointing unit or with a touch.

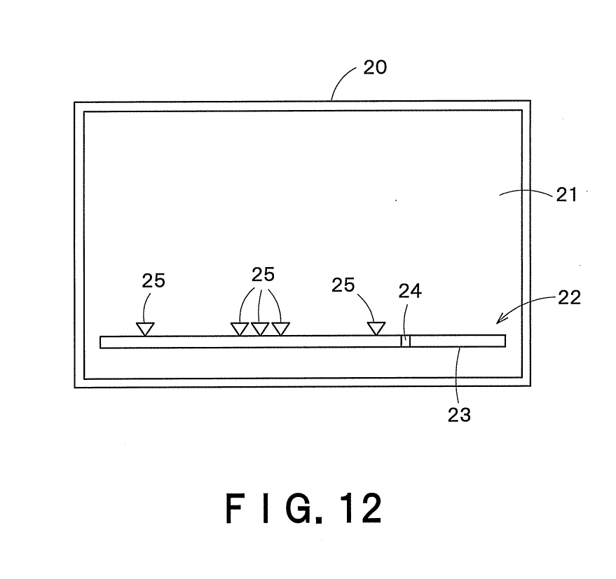

FIG. 12 is a diagram showing a screen example displayed on the information processor 1 according to the eighth embodiment. The information processor 1 according to the eighth embodiment has a display device, and its schematic structure is similar to that of the information processor 1 shown in each of FIGS. 1 to 6, 8, and 10. In a display device 20 of FIG. 12, a reproduction bar 22 is provided in the lower part of a region 21 for displaying digital content being reproduced.

In the reproduction bar 22, a time line 23 representing a time axis for the digital content being reproduced is overlaid with a rectangular mark 24 showing the current reproduction position and inverted triangular marks 25 each showing a reproduction position recorded by the reproduction position information recorder 4.

When a loud noise occurs and new reproduction position information is recorded by the reproduction position information recorder 4, a new inverted triangular marks 25 is correspondingly displayed on the reproduction bar 22.

Accordingly, the user can grasp, at a glance, the number of pieces of recorded reproduction position information and approximate reproduction time of each piece of reproduction position information.

If the display device 20 can function as a touch panel, the user can touch an arbitrary inverted triangular mark 25 on the screen to reproduce the digital content again from that position. Even when a plurality of pieces of reproduction position information are recorded, a specific reproduction position can be selected simply.

Further, the periphery of an arbitrary location on the time line 23 may be enlarged by continuously touching the location for a predetermined time or longer. In this case, the inverted triangular mark 25 can be selected easily, which makes it possible to prevent the user to select an incorrect reproduction position by mistake.

Further, the inverted triangular marks 25 may be partially erased by sequentially touching a plurality of inverted triangular marks 25 arranged close to each other on the time line 23. Instead, the inverted triangular mark 25 may be erased by touching it after pushing an erasing button.

As stated above, in the eighth embodiment, the time line 23 on a time axis for digital content is overlaid with the rectangular mark 24 showing the current reproduction position and the inverted triangular marks 25 each showing a reproduction position recorded by the reproduction position information recorder 4, which makes it possible for the user to previously grasp, at a glance, which reproduction positions are available for return. Further, by pointing an arbitrary inverted triangular mark 25, the user can reproduce the digital content again from the location user desires.

### Other Embodiments

The above embodiments may be arbitrarily combined. For example, the first to fourth embodiments may be arbitrarily combined to record the reproduction position information by extracting arbitrary two or more selected from caption, silence, and switching position from 2D data to 3D data. The combination may have the Back button 10 explained in the fifth embodiment. Further, the combination may have a function of recording the reproduction position information when the Back button 10 is operated, as explained in the sixth embodiment. An arbitrary combination of the first to sixth embodiments may have a function of erasing an old record of the reproduction position information, as explained in the seventh embodiment. Further, an arbitrary combination of the first to seventh embodiments may have the reproduction bar 22, as explained in the eighth embodiment.

Acoustic echo cancelling techniques may be used to remove the sound of digital content reproduced through a speaker from the sound acquired by the microphone 2, in order to detect a noise in the surrounding environment. In this case, characteristics of acoustic transmission from the speaker to the microphone 2 are estimated using the sound of the digital content as a reference signal. Then, the noise in the surrounding environment is detected by subtracting a signal obtained by reflecting the estimated acoustic transmission characteristics in the reference signal from the sound acquired by the microphone 2. When using acoustic echo cancelling techniques, the sound derived from digital content is removed from the sound acquired by the microphone 2, which eliminates the need to set the reference level depending on the speaker volume.

At least a part of the information processor 1 explained in the above embodiments may be formed of hardware or software. In the case of software, a program realizing at least a partial function of the information processor 1 may be stored in a recording medium such as a flexible disc, CD-ROM, etc. to be read and executed by a computer. The recording medium is not limited to a removable medium such as a magnetic disk, optical disk, etc., and may be a fixed-type recording medium such as a hard disk device, memory, etc.

Further, a program realizing at least a partial function of the information processor 1 can be distributed through a communication line (including radio communication) such as the Internet. Furthermore, this program may be encrypted, modulated, and compressed to be distributed through a wired line or a radio link such as the Internet or through a recording medium storing it therein.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An information processor, comprising:
a sound acquisition unit configured to acquire a sound in a surrounding environment;
a volume judging unit configured to judge whether a volume level of the sound acquired by the sound acquisition unit is higher than a reference level previously set; and
a first reproduction position information recorder configured to record reproduction position information showing a current reproduction position of digital content, when the volume judging unit judges that the volume level of the acquired sound is higher than the reference level.

2. The information processor of claim 1,
wherein the volume judging unit defines that the reference level is a volume level higher than a reproduction volume level of headphones or a speaker.

3. The information processor of claim 1, further comprising:
a content storage configured to store digital content to be reproduced,
wherein the first reproduction position information recorder stores the reproduction position information in the content storage while relating the reproduction position information to the digital content currently being reproduced.

4. The information processor of claim 1, further comprising:
a caption extractor configured to extract, from digital content to be reproduced, a renewal position of caption information,
wherein when the volume judging unit judges that the volume level of the acquired sound is higher than the reference level, the first reproduction position information recorder records, as the reproduction position information, a renewal position of caption information preceding the current reproduction position of the digital content.

5. The information processor of claim 1, further comprising:
a silence extractor configured to extract, from digital content to be reproduced, a silent period during which a volume level equal to or lower than a predetermined reference level continues for a predetermined time length or longer time length,
wherein when the volume judging unit judges that the volume level of the acquired sound is higher than the reference level, the first reproduction position information recorder records, as the reproduction position information, an end position of a silent period preceding the current reproduction position of the digital content.

6. The information processor of claim 1, further comprising:
a video type extractor configured to extract, from digital content to be reproduced, a switching position from two-dimensional video data to three-dimensional video data,
wherein when the volume judging unit judges that the volume level of the acquired sound is higher than the reference level, the first reproduction position information recorder records, as the reproduction position information, a switching position from two-dimensional video data to three-dimensional video data preceding the current reproduction position of the digital content.

7. The information processor of claim 1, further comprising:
a video type extractor configured to extract, from digital content to be reproduced, a switching position from monaural audio data to stereo audio data,
wherein when the volume judging unit judges that the volume level of the acquired sound is higher than the reference level, the first reproduction position information recorder records, as the reproduction position information, a switching position from monaural audio data to stereo audio data preceding the current reproduction position of the digital content.

8. The information processor of claim 1, further comprising:
a first backward reproduction instructing unit configured to instruct reproduction of the digital content from a reproduction position corresponding to the reproduction position information recorded by the first reproduction position information recorder.

9. The information processor of claim 8, further comprising:
a second reproduction position information recorder configured to record the reproduction position of the digital content reproduced at the point when the instruction by the first backward reproduction instructing unit is given; and
a second backward reproduction instructing unit configured to instruct reproduction of the digital content from the reproduction position recorded by the second reproduction position information recorder, after the reproduction position of the digital content is changed in accordance with the instruction by the first backward reproduction instructing unit.

10. The information processor of claim 9,
wherein the instructions by the first backward reproduction instructing unit and the second backward reproduction instructing unit are given by operating the same button.

11. The information processor of claim 1, further comprising:
a first reproduction position information eraser configured to erase at least a piece of the reproduction position information recorded by the first reproduction position information recorder when the number of pieces of the reproduction position information recorded within a predetermined time interval exceeds a predetermined threshold value.

12. The information processor of claim 1, further comprising:
a second reproduction position information eraser configured to erase a piece of the reproduction position information recorded by the first reproduction position information recorder when a predetermined time has passed since the piece of the reproduction position information was recorded.

13. The information processor of claim 1, further comprising:
a display controller configured to display, on a display device, a time line representing a time axis for digital content to be reproduced, the time line being synthetically overlaid with an index showing a current reproduction position of the digital content and an index showing the reproduction position information recorded by the first reproduction position information recorder.

14. A recording medium recording a program executed by a computer,
the program comprising:
detecting a volume level in a surrounding environment;
judging whether the detected volume level is higher than a reference level previously set; and
recording reproduction position information showing a current reproduction position of digital content, when the detected volume level is judged to be higher than the reference level.

15. An information processing method, comprising:
acquiring a sound in a surrounding environment;
judging whether a volume level of the acquired sound is higher than a reference level previously set; and
recording reproduction position information showing a current reproduction position of digital content, when the volume level of the acquired sound is judged to be higher than the reference level.

16. The method of claim 15,
wherein it is defined that the reference level is a volume level higher than a reproduction volume level of headphones or a speaker.

17. The method of claim 15, further comprising:
storing digital content to be reproduced,
wherein the reproduction position information is stored in the content storage while relating the reproduction position information to the digital content currently being reproduced.

18. The method of claim 15, further comprising:
extracting, from digital content to be reproduced, a renewal position of caption information,
wherein when it is judged that the volume level of the acquired sound is higher than the reference level, a renewal position of caption information preceding the current reproduction position of the digital content is recorded as the reproduction position information.

19. The method of claim 15, further comprising:
extracting, from digital content to be reproduced, a silent period during which a volume level equal to or lower than a predetermined reference level continues for a predetermined time length or longer time length,
wherein when it is judged that the volume level of the acquired sound is higher than the reference level, an end position of a silent period preceding the current reproduction position of the digital content is recorded as the reproduction position information.

20. The method of claim 15, further comprising:
extracting, from digital content to be reproduced, a switching position from two-dimensional video data to three-dimensional video data,
wherein when it is judged that the volume level of the acquired sound is higher than the reference level, a switching position from two-dimensional video data to three-dimensional video data preceding the current reproduction position of the digital content is recorded as the reproduction position information.
